(19) United States
(12) Patent Application Publication
(10) Pub. No.: US 2025/0206089 A1
(43) Pub. Date: Jun. 26, 2025

(54) SYSTEMS AND METHODS FOR TRAILER POSE MEASUREMENT

(71) Applicant: Torc Robotics, Inc., Blacksburg, VA (US)

(72) Inventors: Joseph R. Fox-Rabinovitz, Blacksburg, VA (US); Adam Shoemaker, Blacksburg, VA (US); William Davis, Blacksburg, VA (US); Akshay Pai Raikar, Blacksburg, VA (US)

(21) Appl. No.: 18/394,231

(22) Filed: Dec. 22, 2023

(51) Int. Cl. B60D 1/62

(52) U.S. Cl. CPC B60D 1/62

(57) ABSTRACT

In one aspect, the disclosed system for measuring a pose of a trailer connected to an autonomous truck includes a trailer pose sensor and an autonomy computing system. The sensor is coupled to a connector configured to rigidly mate with a trailer connector on the trailer. The sensor is configured to detect a motion of the trailer. The autonomy computing system is communicatively coupled to the sensor. The autonomy computing system includes a processor coupled to a memory, the memory storing executable instructions that, upon execution by the processor, configure the processor to: compute a first pose of the trailer and store in the memory, receive a first measurement of the motion from the sensor, compute a second pose based at least in part on the first measurement received from the sensor and the first pose, and store the second pose in the memory.

### TECHNICAL FIELD

The field of the disclosure relates generally to autonomous vehicles and, more specifically, to systems and methods for measuring the pose of a trailer connected to an autonomous truck.

### BACKGROUND OF THE INVENTION

For a typical tractor trailer, the trailer itself is generally the heaviest and largest component. Consequently, precise control of the trailer is critical to safety and the ability to operate according to safety rules, regulations, and traffic laws. A traditional tractor trailer is operated by a human who can visually ascertain the position, attitude, and motion of the trailer, and can make control decisions based on that perception, including, for example, acceleration or deceleration, or steering.

For an autonomous truck, the trailer is an equally critical component of safety and operation. However, without a driver or other operator in the loop, the position and attitude of the trailer (collectively referred to as the “pose”) must be sensed, detected, or otherwise measured by one or more sensors. Moreover, because perception, planning, and control functionalities are generally limited to the autonomous truck itself, to the exclusion of the trailer, the sensors available to measure trailer pose are likewise limited to being housed or coupled to the truck itself, i.e., the tractor. In other words, sensors for an autonomous truck are on the truck and not on the trailer. Such sensors typically include radio detection and ranging (RADAR), cameras, acoustic sensing, or light detection and ranging (LiDAR) devices mounted on the truck with the trailer in their field of view.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed system for measuring a pose of a trailer connected to an autonomous truck includes a trailer pose sensor and an autonomy computing system. The trailer pose sensor is coupled to a connector configured to rigidly mate with a trailer connector on the trailer. The trailer pose sensor is configured to detect a motion of the trailer. The autonomy computing system is communicatively coupled to the trailer pose sensor. The autonomy computing system includes a processor coupled to a memory, the memory storing executable instructions that, upon execution by the processor, configure the processor to: compute a first pose of the trailer and store in the memory, receive a first measurement of the motion from the trailer pose sensor, compute a second pose based at least in part on the first measurement received from the trailer pose sensor and the first pose, and store the second pose in the memory.

In another aspect, the disclosed system for measuring a pose of a trailer connected to an autonomous truck includes an autonomy computing system. The autonomy computing system is communicatively coupled to a trailer pose sensor. The autonomy computing system includes a processor coupled to a memory, the memory storing executable instructions that, upon execution by the processor, configure the processor to: compute a first pose of the trailer and store in the memory, receive a first measurement of motion from a trailer pose sensor coupled to a connector rigidly mated with a trailer connector on the trailer, compute a second pose based at least in part on the first measurement received from the trailer pose sensor and the first pose, and store the second pose in the memory.

In yet another aspect, the disclosed method of measuring a pose of a trailer connected to an autonomous truck includes storing a first pose of the trailer in a section of memory. The method includes receiving a first inertial measurement from an inertial measurement unit (IMU) coupled to a connector rigidly mated with a trailer connector on the trailer. The method includes computing a second pose based at least in part on the first inertial measurement received from the IMU and the first pose. The method includes storing the second pose in the section of memory.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is an illustration of an example autonomous truck;

FIG. 2 is another illustration of an example autonomous truck coupled to a trailer;

FIG. 3 is a detailed view of the autonomous truck and trailer shown in FIG. 2;

FIG. 4 is a schematic diagram of example connector housings for air hose connections between the autonomous truck and trailer shown in FIGS. 2-3;

FIG. 5 is a schematic diagram of an example electrical cable for electrical connections between the autonomous truck and trailer shown in FIGS. 2-3;

FIG. 6 is a functional block diagram of an example embodiment of an autonomous vehicle;

FIG. 7 is a schematic diagram of an example embodiment of the autonomy computing system shown in FIG. 6; and

FIG. 8 is a flow diagram of an example embodiment of a method of measuring the pose of a trailer connected to an autonomous truck.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

Trailer pose measurement systems for trucks may include a RADAR, LiDAR, or camera mounted on the truck with the trailer in the field of view, i.e., “looking” at the trailer. However, trailers vary greatly, which results in greater time spent training and calibrating the trailer pose measurement system to a given trailer.

The disclosed systems and methods employ a trailer pose sensor mounted at the physical connection points between an autonomous truck and the trailer. Each trailer physically connects to the autonomous truck at the “king pin,” a primary and second air hose connection, and an electrical cable connection. The disclosed systems include one or more trailer pose sensors coupled to one or more of the air hose or electrical connectors that rigidly mate with a corresponding trailer connector. Although the air hoses and electrical cable are flexible and generally move freely behind a truck, their connectors, when mated with their corresponding trailer connector, are relatively static. Moreover, the connector housings can be easily added to or modified to house one or more sensors. Power for the disclosed sensors is provided from the autonomous truck via a plurality of conductors that coextend with the air hose or electrical cable. Likewise, data to and from the sensors may be conducted, or carried, by one or more additional conductors. Alternatively, data may be transmitted to or received from the trailer pose sensors wirelessly over a suitable wireless channel, e.g., NFC, Wi-Fi, Bluetooth, etc.

The disclosed systems and methods may employ one or more of a variety of sensor modalities for the trailer pose sensor, including, for example, an inertial measurement unit (IMU), camera, infrared sensor, ultrasound, LiDAR, RADAR, or laser rangefinder, among others. The disclosed systems may employ multiple sensor modalities on a given connector, and may utilize trailer pose sensors on multiple connection points. For example, a trailer pose sensor may be integrated into connectors on one or both air hoses, on the electrical cable, or any combination of the three.

The disclosed trailer pose sensors detect motion of the trailer. Such motion may be absolute motion or relative motion, i.e., relative to the autonomous truck. Motion is generally measured in three dimensions, for example, along axes aligned to the trailer body. Examples of body-frame axis combinations include forward-right-down (FRD) and forward-left-up (FLU). Once an initial trailer pose is known, motion can be detected, for example, by a camera, or measured by one or more IMUs and accumulated, or integrated, over time to periodically compute, or recompute, the trailer pose, which is a combination of position and attitude. In one embodiment, the trailer pose sensor includes an IMU, which includes accelerometers for measuring linear acceleration in three dimensions and gyroscopes for measuring angular rates, or angular velocity, about three axes, i.e., the pitch, roll, and yaw axes. Generally, the pitch axis extends laterally across the trailer, e.g., from left to right; the roll axis extends longitudinally along the length of the trailer; and the yaw axis extends vertically through the king pin of the trailer. One or more IMUs may operate in concert with other sensors on the autonomous truck, for example, for correcting drift in the IMUs; or in combination with one or more cameras of the disclosed trailer pose measurement system for detecting relative movement between the truck and trailer, as well as for correcting drift in the IMUs.

In alternative embodiments, motion may be measured by one or more cameras as trailer pose sensors, with a forward field of view, i.e., with the autonomous truck in the field of view. Captured RGB images are processed to identify the autonomous truck in the field of view, as well as any changes in position or attitude of the autonomous truck in the frame. Such changes in position or attitude of the autonomous truck are translated to motion of the trailer. Similarly, one or more frames captured by the camera may be employed to calibrate the trailer pose measurement system, which is to establish an initial trailer pose.

Image processing algorithms, or models, may be trained to recognize particular features on the rear of the autonomous truck, such as body panels, lights, trim pieces, access doors, or graphics, among others. Image processing algorithms may be embodied in a hardware image signal processor, CPU, GPU, DSP, ASIC, or other suitable processor. Alternatively, image processing algorithms may be embodied in a software-defined image signal processor executing on another CPU, GPU, DSP, ASIC, or other suitable processor.

The disclosed systems and methods compute trailer pose in two components: position and attitude. Trailer position may be determined directly by employing cameras, LiDAR, or other sensors to detect position. Trailer position may also be computed by integrating acceleration measurements. The position component of trailer pose may be computed as an absolute position or a relative position, i.e., relative to the autonomous truck. For a relative position, the measured accelerations are corrected, or adjusted, by measurements of truck acceleration, e.g., from an IMU on the truck itself. Trailer attitude is computed by integrating angular rate or velocity measurements. Likewise, the attitude component of trailer pose may be computed as an absolute attitude or a relative attitude, i.e., relative to the autonomous truck. For a relative attitude, the measured angular rates are corrected, or adjusted, by measurements of truck angular rates from the IMU on the truck.

The disclosed systems and methods include a processing system such as an autonomy computing system or another embedded computing system, such as an electronic control unit (ECU). The processing system includes at least one or more processors and one or more memory devices. The one or more memory devices include a section of memory storing a trailer pose measurement module, which may be a hardware module, a software module, or a combination of hardware and software. The one or more memory devices include a section of memory for storing trailer pose measurements, which may include an initial trailer pose, updated, or recomputed trailer pose, or individual measurements of linear acceleration or angular rate. The same processing system may later gain access to the stored trailer pose and employ the trailer pose in executing a motion estimation module, a behavior and planning module, or a control module, among others. Alternatively, one or more additional processing systems, such as another autonomy computing system or an ECU may gain access to the section of memory storing the trailer pose and employ the trailer pose in executing a motion estimation module, a behavior and planning module, or a control module, among others. In alternative embodiments, the processing system may transmit a computed trailer pose over one or more wired or wireless communication channels to one or more other processing systems, such as an autonomy computing system or an ECU. Wired communication channels may include a serial bus, a peripheral bus, CAN bus, or other suitable data link. Wireless communication channels may include Wi-Fi, NFC, Bluetooth, or other suitable data link.

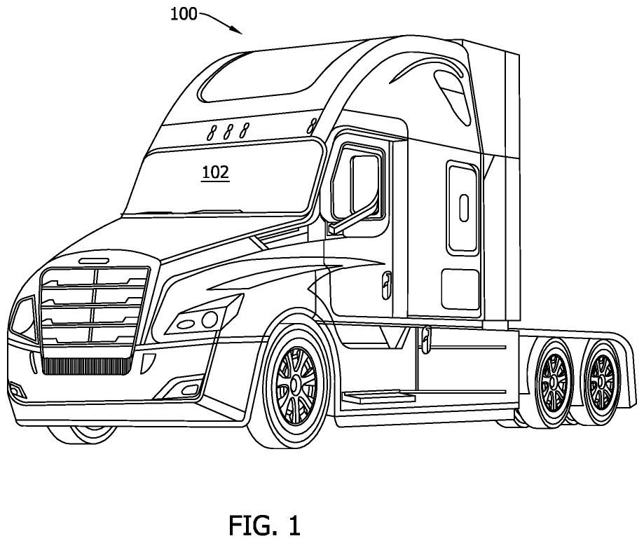

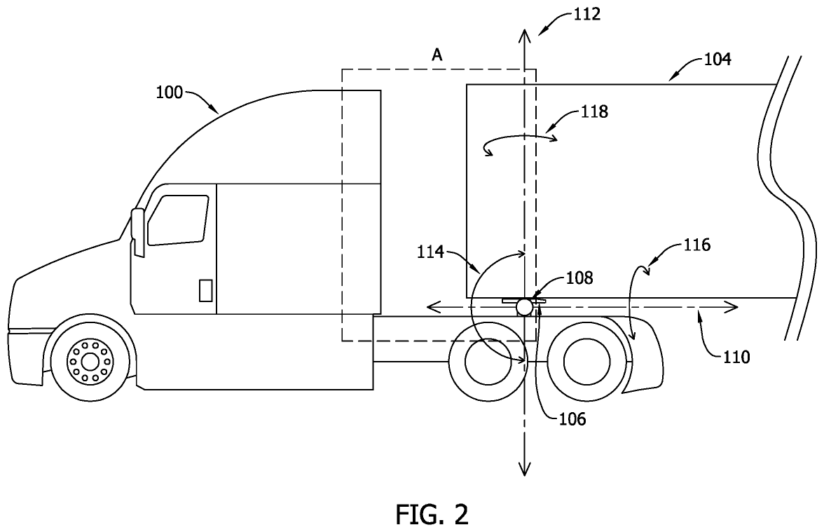

FIG. 1 is an illustration of an example autonomous truck 100 including a cab 102. Other example autonomous trucks may exclude cab 102 when no human driver is required. FIG. 2 is another illustration of the autonomous truck 100 coupled to a trailer 104 at a king pin and fifth wheel coupling 106. FIG. 2 further illustrates three example axes defining a reference frame: a lateral axis 108 extending laterally from side to side of trailer 104, a longitudinal axis 110 extending longitudinally the length of trailer 104, and a vertical axis 112 extending vertically through trailer 104. Linear accelerations may be measured along these axes, and angular rates are measured about these axes, i.e., pitch 114 is measured about lateral axis 108, roll 116 is measured about longitudinal axis 110, and yaw 118 is measured about vertical axis 112.

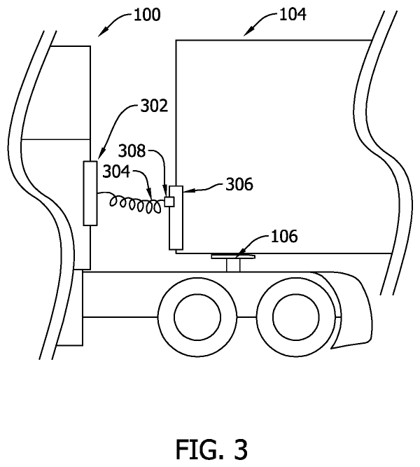

FIG. 3 is a detailed view of section A of autonomous truck 100 and trailer 104 shown in FIG. 2. Autonomous truck 100 includes a truck interface 302 to which one or more air hoses or electrical cables 304 may be coupled. Air hoses or electrical cables 304 extend toward trailer 104 to mate with a trailer interface 306. Trailer interface 306 includes one or more rigidly mounted trailer connectors for receiving air hose connectors or electrical cable connectors for the purpose of brake control, emergency brake control, lights, or signaling, among other functions. The one or more air hoses or electrical cables 304 include a connector 308 configured to rigidly mate with the truck connector on trailer 104.

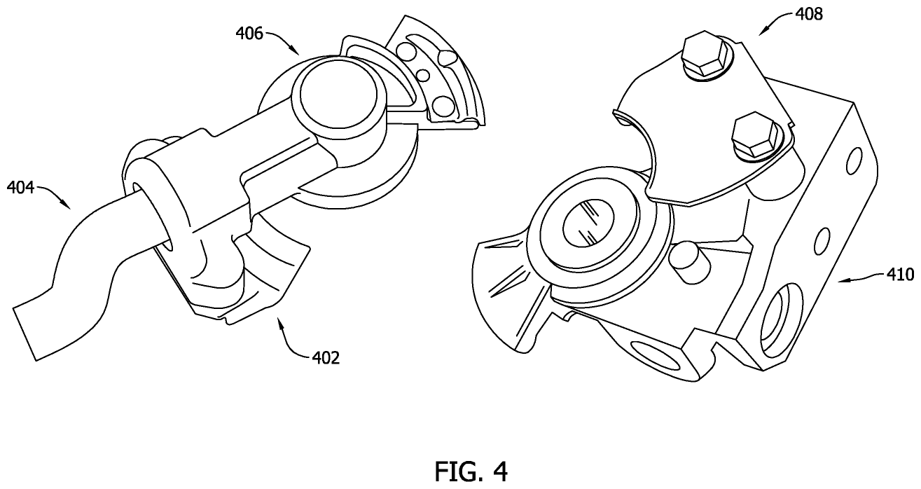

FIG. 4 is a schematic diagram of example standard connector housings for air hose connections between an autonomous truck and a trailer, such as autonomous truck 100 and trailer 104 shown in FIGS. 2-3. An air hose connector 402 is illustrated with a segment of an air hose 404. Air hose connector 402 includes a connector body 406 to which a trailer pose sensor is coupled. FIG. 4 also illustrates a trailer connector 408 configured to rigidly mate air hose connector 402. Trailer connector 408 includes a connector body 410 configured to mount on a trailer at a trailer interface, such as trailer interface 306 on trailer 104 shown in FIG. 3.

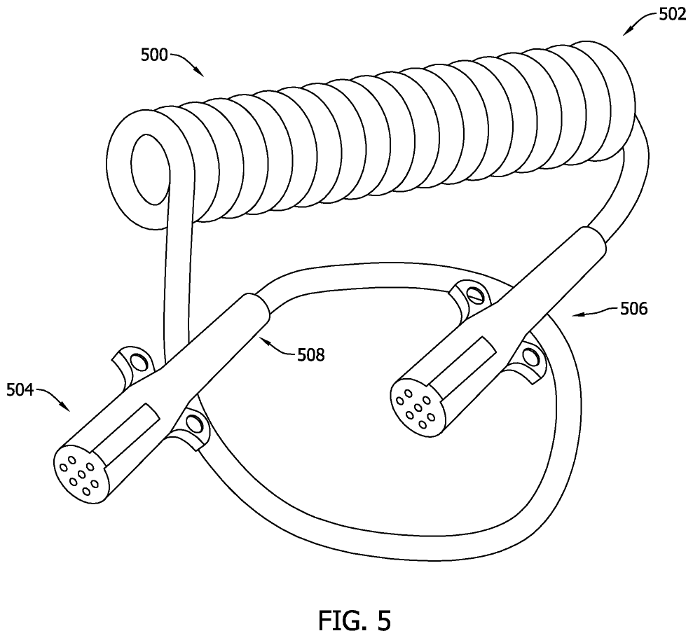

FIG. 5 is a schematic diagram of an example electrical cable 500 for electrical connections between an autonomous truck and trailer, such as autonomous truck 100 and trailer 104 shown in FIGS. 2-3. Electrical cable 500 includes a bundle of conductors 502 having a first connector 504 and second connector 506 on either end. Connector 504 includes a connector body 508 to which a trailer pose sensor is coupled. Connector 504 is configured to rigidly mate a trailer electrical connector at a trailer interface on a trailer, such as trailer interface 306 on trailer 104 shown in FIG. 3.

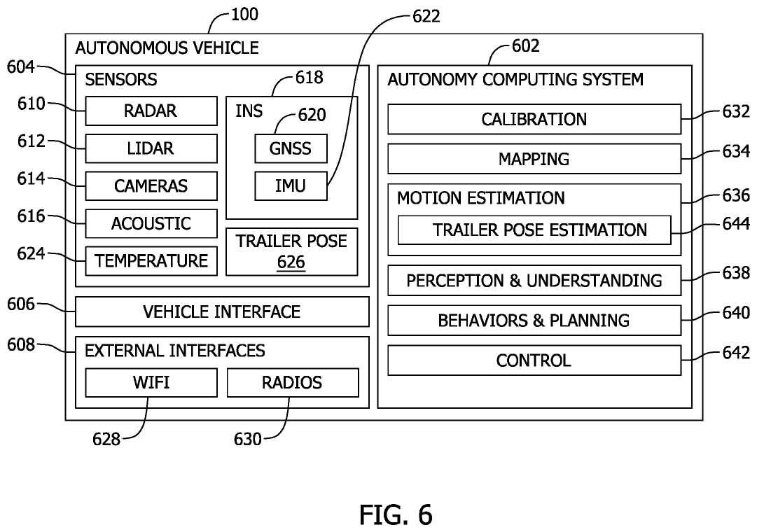

FIG. 6 is a functional block diagram of an example embodiment of autonomous vehicle 100. In the example embodiment, autonomous vehicle 100 includes an autonomy computing system 602, sensors 604, a vehicle interface 606, and external interfaces 608.

In the example embodiment, sensors 604 include various sensors such as, for example, RADAR sensors 610, LiDAR sensors 612, cameras 614, acoustic sensors 616, temperature sensors 624, and inertial navigation system (INS) 618, which includes one or more global navigation satellite system (GNSS) receivers 620 and at least one inertial measurement unit (IMU) 622. Sensors 604 include at least one trailer pose sensor 626 coupled to one or more air hose connectors, such as air hose connector 402 shown in FIG. 4, or electrical cable connectors, such as first connector 504 of electrical cable 500 shown in FIG. 5, configured to mate corresponding trailer connectors on a trailer, such as trailer 104. Other sensors 604 not shown in FIG. 6 may include, for example, acoustic (e.g., ultrasound), internal vehicle sensors, meteorological sensors, or other types of sensors. Sensors 604 generate respective output signals based on detected physical conditions of autonomous vehicle 100 and its proximity. As described in further detail below, these signals may be used by autonomy computing system 602 to determine how to control operation of autonomous vehicle 100.

Cameras 614 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 614 and the images from each of the multiple cameras 614 may be stitched or combined to generate a visual representation of the multiple cameras' fields of view, which may be used to, for example, generate a bird's eye view of the environment surrounding autonomous vehicle 100. In some embodiments, the image data generated by cameras 614 may be sent to autonomy computing system 602 or other aspects of autonomous vehicle 100 and this image data may include autonomous vehicle 100 or a generated representation of autonomous vehicle 100. In some embodiments, one or more systems or components of autonomous vehicle 100 may overlay labels to the features depicted in the image data, such as on a raster layer or other semantic layer of a high-definition (HD) map.

LiDAR sensors 612 generally include a laser generator and a detector that send and receive a LiDAR signal. The LiDAR signal can be emitted and received from any direction such that LiDAR point clouds (or “LiDAR images”) of the areas ahead of, to the side, behind, above, or below autonomous vehicle 100 can be captured and represented in the LiDAR point clouds. In some embodiments, autonomous vehicle 100 includes multiple LiDAR lasers and LiDAR sensors 612 and the LiDAR point clouds from each of the multiple LiDAR sensors 612 may be stitched or combined to generate a LiDAR-based representation of the area in the field of view of the LiDAR signal(s). In some embodiments, the LiDAR point cloud(s) generated by the LiDAR sensors and sent to autonomy computing system 602 and other aspects of autonomous vehicle 100 may include a representation of or other data relating to autonomous vehicle 100, such as a location of autonomous vehicle 100 with respect to other detected objects. In some embodiments, the system inputs from cameras 614 and the LiDAR sensors 612 may be fused or used in combination to determine conditions (e.g., locations of other objects) around autonomous vehicle 100.

One or more GNSS receivers 620 are positioned on autonomous vehicle 100 and may be configured to determine a location of autonomous vehicle 100, which it may embody as GNSS data, as described herein. When multiple GNSS receivers 620 are employed, attitude about one or more axes may be computed for autonomous vehicle 100. GNSS receivers 620 may be configured to receive one or more signals from a global navigation satellite system (e.g., global positioning system (GPS) constellation) to localize autonomous vehicle 100 via geolocation. In some embodiments, GNSS receiver 620 may provide an input to or be configured to interact with, update, or otherwise utilize one or more digital maps, such as an HD map (e.g., in a raster layer or other semantic map) using mapping module 634. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 622 is an electronic device that measures and reports one or more features regarding the motion of autonomous vehicle 100. For example, IMU 622 may measure a velocity, acceleration, angular rate, and or an orientation of autonomous vehicle 100 or one or more of its individual components using a combination of accelerometers, gyroscopes, or magnetometers. IMU 622 may detect linear acceleration using one or more accelerometers and rotational rate using one or more gyroscopes and attitude information from one or more magnetometers. In some embodiments, IMU 620 may be communicatively coupled to one or more other systems, for example, GNSS receiver 620 and may provide an input to and receive an output from GNSS receiver 620.

In the example embodiment, external interfaces 608 are configured to enable autonomous vehicle 100 to communicate with an external network via, for example, a wired or wireless connection, such as Wi-Fi 628 or other radios 630. In embodiments including a wireless connection, the connection may be a wireless communication signal (e.g., Wi-Fi, cellular, LTE, 5g, Bluetooth, etc.). However, in some embodiments, external interfaces 608 may be configured to communicate with an external network via a wired connection, such as, for example, during testing of autonomous vehicle 100 or when downloading mission data after completion of a trip. The connection(s) may be used to download and install programs or executables in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 608 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 602 is implemented by one or more processors and memory devices of autonomous vehicle 100. Autonomy computing system 602 includes modules, which may be hardware components (e.g., processors or other circuits) or software components (e.g., computer applications or processes executable by autonomy computing system 602), or a combination of hardware and software, configured to generate outputs, such as control signals, based on inputs received from, for example, sensors 604. These modules may include, for example, a calibration module 632, a mapping module 634, a motion estimation module 636, a perception and understanding module 638, a behaviors and planning module 640, and a control module 642. In the example embodiment, control module 642 is configured, for example, to send one or more signals to the various aspects of autonomous vehicle 100 that directly control the motion of autonomous vehicle 100 (e.g., engine, throttle, steering wheel, brakes, etc.) or other components.

Motion estimation module 636 includes a trailer pose estimation module 644. Trailer pose estimation module 644 is configured to compute the pose of, for example, trailer 104 coupled to autonomous truck 100. More specifically, trailer pose estimation module 644 is configured to compute an initial pose, or a first pose, of trailer 104 and store the computed pose in memory. Trailer pose estimation module 644 receives measurements of motion from trailer pose sensor 626. Trailer pose estimation module 644 computes a second pose, or an updated trailer pose, based at least in part on the measurements of motion received from trailer pose sensor 626 and the initial pose. The recomputed pose is stored in memory. The first pose or other prior computed poses may be overwritten in memory, discarded, or retained.

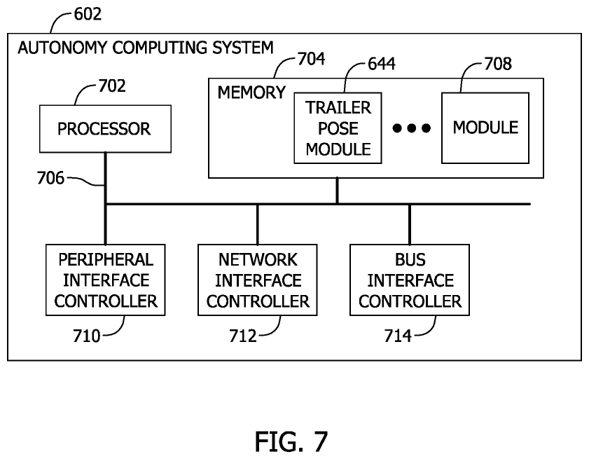

FIG. 7 is a schematic diagram of an example embodiment of autonomy computing system 602 shown in FIG. 6. Autonomy computing system 602 includes at least one processor 702 and a memory 704. Processor 702 is coupled to memory 704 via a system bus 706. In the example embodiment, memory 704 includes one or more devices that enable information, such as executable instructions or other data, to be stored and retrieved. Memory 704 includes one or more computer readable media, such as, without limitation, dynamic random access memory (DRAM), static random access memory (SRAM), a solid state disk, or a hard disk. In the example embodiment, memory 704 stores, without limitation, application source code, application object code, configuration data, additional input events, application states, assertion statements, validation results, or any other type of data. In particular, memory 704 stores trailer pose module 644, including program code, and one or more additional software modules 708.

Autonomy computing system 602 further includes various interface controllers for communicating with other processing systems of autonomous truck 100, data networks, peripheral devices, sensors, controllers, ECUs, or one or more other systems or subsystems of autonomous truck 100. The interface controllers include a peripheral interface controller 710 for communicating with one or more peripheral devices, such as sensors 604 shown in FIG. 6, or trailer pose sensor 626, also shown in FIG. 6. The interface controllers include a network interface controller 712 for communicating over one or more data networks, such as the Internet. The interface controllers include a bus interface controller 714 for communicating with one or more devices sitting on a bus, such as a CAN bus local to autonomous truck 100.

In the example embodiment, processor 702 is configured by gaining access to one or more sections of program code in memory 704 or another memory device, and executing that program code to perform one or more functions. In operation, a processor 702 executes computer-executable instructions embodied in one or more computer-executable components stored on one or more computer-readable media, such as memory 704, to implement, for example, trailer pose estimation module 644.

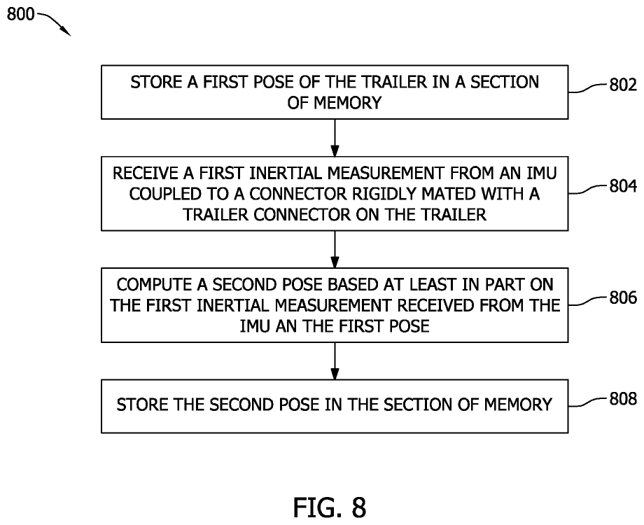

FIG. 8 is a flow diagram of an example embodiment of a method 800 of measuring the pose of a trailer connected to an autonomous truck, such as trailer 104 coupled to autonomous truck 100 shown in FIGS. 2-3. Method 800 may be embodied, for example, in autonomy computing system 602 shown in FIGS. 6-7. Method 800 is described herein with respect to FIGS. 2-3 and 6-7. Method 800 includes storing 802 an initial pose, or a first pose, in a section of memory, such as memory 704. First inertial measurements are received 804 from trailer pose sensor 626, such as an IMU, coupled to a connector rigidly mated with a trailer connector on the trailer, such as connector 308 mated with a connector coupled to trailer interface 306. A second pose is computed 806 based at least in part on the first inertial measurements received from the IMU and the first pose. The second pose is stored 808 in the section of memory.

An example technical effect of the methods, systems, and apparatus described herein includes at least one of: (a) measuring trailer pose by a sensor effectively rigidly coupled to the trailer; (b) incorporating a trailer pose sensor within a connector body, or housing, that remains with the autonomous truck; (c) improved precision of trailer pose estimation; and (d) improved control characteristics for the autonomous truck and trailer.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary embodiment” are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for measuring a pose of a trailer connected to an autonomous truck, the system comprising:
a trailer pose sensor coupled to a connector configured to rigidly mate with a trailer connector on the trailer, and further configured to detect a motion of the trailer; and
an autonomy computing system communicatively coupled to the trailer pose sensor, the autonomy computing system comprising a processor coupled to a memory, the memory storing executable instructions that, upon execution by the processor, configure the processor to:
compute a first pose of the trailer and store in the memory;
receive a first measurement of the motion from the trailer pose sensor;
compute a second pose based at least in part on the first measurement received from the trailer pose sensor and the first pose; and
store the second pose in the memory.

2. The system of claim 1 further comprising a truck inertial measurement unit (IMU) coupled to the autonomous truck and configured to generate at least one inertial measurement for the autonomous truck, and wherein the processor is further configured to compute the second pose by computing the second pose based at least in part on the at least one inertial measurement from the truck IMU.

3. The system of claim 1, wherein the trailer pose sensor comprises at least one inertial measurement unit (IMU) coupled to the connector.

4. The system of claim 3, wherein the at least one IMU comprises at least one accelerometer and at least one gyroscope for each of a pitch axis, a roll axis, and a yaw axis.

5. The system of claim 1, wherein the trailer pose sensor comprises a camera coupled to the connector.

6. The system of claim 1 further comprising an air hose assembly comprising:
the connector configured to rigidly mate with the trailer connector on the trailer; and
at least one conductor configured to electrically couple the trailer pose sensor to a sensor interface on the autonomous truck.

7. The system of claim 6, wherein the at least one conductor includes a plurality of conductors for supplying power to the trailer pose sensor, and at least one data conductor for conducting communication signals between the trailer pose sensor and the autonomy computing system.

8. A system for measuring a pose of a trailer connected to an autonomous truck, the system comprising:
an autonomy computing system communicatively coupled to a trailer pose sensor, the autonomy computing system comprising a processor coupled to a memory, the memory storing executable instructions that, upon execution by the processor, configure the processor to:
compute a first pose of the trailer and store in the memory;
receive a first measurement of motion from a trailer pose sensor coupled to a connector rigidly mated with a trailer connector on the trailer;
compute a second pose based at least in part on the first measurement received from the trailer pose sensor and the first pose; and
store the second pose in the memory.

9. The system of claim 8 wherein the processor is further configured to receive at least one inertial measurement from a truck inertial measurement unit (IMU) coupled to the autonomous truck, and wherein the processor is further configured to compute the second pose by computing the second pose based at least in part on the at least one inertial measurement from the truck IMU.

10. The system of claim 8, wherein the trailer pose sensor comprises at least one inertial measurement unit (IMU) coupled to the connector.

11. The system of claim 10, wherein the processor is further configured to receive the first measurement of motion including an acceleration and angular velocity for each of a pitch axis, a roll axis, and a yaw axis.

12. The system of claim 8, wherein the trailer pose sensor comprises a camera coupled to the connector, the camera configured to capture a frame including the autonomous truck.

13. The system of claim 12, wherein the processor is further configured to compute the first pose of the trailer based at least in part on the frame captured by the camera.

14. The system of claim 8 further comprising:
receiving a second measurement of motion from a second IMU coupled to a second connector rigidly mated with a second trailer connector on the trailer;
computing an average of the first measurement and the second measurement; and
computing the second pose based at least in part on the average.

15. A method of measuring a pose of a trailer connected to an autonomous truck, the method comprising:
storing a first pose of the trailer in a section of memory;
receiving a first inertial measurement from an inertial measurement unit (IMU) coupled to a connector rigidly mated with a trailer connector on the trailer;
computing a second pose based at least in part on the first inertial measurement received from the IMU and the first pose; and
storing the second pose in the section of memory.

16. The method of claim 15 further comprising computing the first pose based on initial position measurements of the trailer.

17. The method of claim 15 further comprising:
receiving a second inertial measurement from a second IMU;
computing an average of the first inertial measurement and the second inertial measurement; and
computing the second pose based at least in part on the average.

18. The method of claim 15 further comprising receiving at least one inertial measurement from a truck IMU coupled to the autonomous truck, and wherein computing the second pose further comprises computing the second pose based at least in part on the at least one inertial measurement from the truck IMU.

19. The method of claim 15 further comprising initiating an adjustment of a suspension system for the trailer.

20. The method of claim 15 further comprising gaining access, by a behavior and planning module, to the second pose in the section of memory and instructing a control module to modify acceleration control or steering control of the autonomous truck.
